(19) United States
(12) Patent Application Publication
(10) Pub. No.: US 2008/0010091 A1
(43) Pub. Date: Jan. 10, 2008

(54) Method and System for Sharing a User-Medical-Record

(76) Inventors: SeungYeon Kim, Seoul (KR); Marcel C. Rosu, Ossining, NY (US); MyungChul Lee, Seoul (KR)

Correspondence Address: IBM CORPORATION, T.J. WATSON RESEARCH CENTER, P.O. BOX 218, YORKTOWN HEIGHTS, NY, 10598, US

(21) Appl. No.: 11/456,280

(22) Filed: Jul. 10, 2006

(51) Int. Cl. G06F 19/00

(52) U.S. Cl. 705/3

(57) ABSTRACT

The present invention relates to a method and system for sharing a user-medical-record belonging to a user. The method comprises storing at least one of the user-medical-record and a secure-reference to the user-medical-record in a user-computing-device. The method further comprises transferring one of the user-medical-record and the secure-reference to an emergency service provider. The user is one of a registered-user and a non-registered-user, wherein the registered-user is associated with the emergency service provider and the non-registered-user is disassociated with said emergency service provider.

### FIELD OF THE INVENTION

The present invention relates to emergency health care services and more specifically, to a method and a system for sharing a user-medical-record with emergency service providers.

### BACKGROUND OF THE INVENTION

The exchange of user-medical-records between several hospitals or between hospitals and emergency medical services is essential for users to get continuous medical services. Conventionally, hospitals maintain medical information database to store user-medical-record for each user. The medical information database is updated as and when a user is treated for an illness and the corresponding user-medical-records are also updated. For example, every time a user visits the hospital for a check up, the medical information database of the hospital is updated to incorporate the most recent medical records of the user.

Several service providers exist, who provide the emergency service providers with user-medical-records required for carrying out treatment of a user. The user needs to subscribe to the service providers and provide information related to the user's medical history along with a significant amount of private data. The user needs to pay a subscription fee and a maintenance fee for subscribing to the service providers. The information is stored on centralized servers with the service providers. In case of an emergency, a health care system, an emergency service provider or a hospital can retrieve the information from the service providers.

Another method and system as disclosed in the US patent publication no. 2005,006,0187, titled “Patient information management system for clinical evaluation and content delivery”, comprises receiving medical information from a patient through a patient portal into a central server and providing the medical information to a physician through a physician portal that is in communication with the central server. The patient utilizes a communications device, such as a personal computer, telephone, facsimile machine, PDA, cell phone, pager or the like to interconnect with the patient portal through the communications medium. The communications medium may be a local area network (LAN), wide area network (WAN), telephone line, satellite communications link, cellular communications link, digital network link, or the like. An electronic medical record is maintained for each patient at the central server and is updated periodically.

However, there can be users who are not subscribed to any service provider. This situation can primarily arise when the users are either not willing to pay for the subscription services or when the users are unwilling to provide private information to any service provider in advance. The user-medical-records of such unsubscribed users can not be easily shared with an emergency service provider, a health care system or a hospital in case of an emergency.

### SUMMARY OF THE INVENION

It is therefore an aspect of the present invention is to provide a method and a system for sharing a user-medical-record with at least one emergency service provider or at least one medical-service-computing-device using a user-computing-device.

It is another aspect of the present invention is to provide a method and a system for accessing a user-medical-record stored in a user-computing-device.

A method for sharing a user-medical-record belonging to a user in accordance with the present invention includes storing at least one of the user-medical-record and a secure-reference to the user-medical-record in a user-computing-device. In response to storing the user-medical-record, the user-medical-record or the secure-reference is transferred to an emergency service provider. The user can be a registered-user or a non-registered-user. The registered-user is associated with the emergency service provider and the non-registered-user is disassociated with said emergency service provider.

In an embodiment of the present invention a medical-service-computing-device can request the user-computing-device for the user-medical-record or the secure-reference to the user-medical-record. Further, in response to the request, one of the user-medical-record and the secure-reference is received at the medical-service-computing-device from the user-computing-device. The medical-service-computing-device can belong to an emergency crew or a health care system.

In another embodiment of the present invention, a user-computing-device is provided for sharing a user-medical-record. The user-computing-device comprises a transceiver, a processor coupled to the transceiver, a memory coupled to the processor, and an emergency software program residing in the memory. The memory is configured to store at least one of a user-medical-record and a secure-reference to the user-medical-record.

### BRIEF DESCRIPTION OF THE DRAWINGS

The foregoing objects and advantages of the present invention for a method of sharing a user-medical-record may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 illustrates a block diagram depicting a user-computing-device sharing a user-medical-record in accordance with an embodiment of the present invention.

FIG. 2 illustrates a flow diagram of a method of sharing a user-medical-record belonging to a user in accordance with an embodiment of the present invention.

FIG. 3 illustrates a flow diagram of a method of transferring a user-medical-record or a secure-reference to the user-medical-record in accordance with an embodiment of the present invention.

FIG. 4 illustrates a flow diagram of a method of accessing a user-medical-record in accordance with an embodiment of the present invention.

FIG. 5 illustrates a block diagram of a user-computing-device in accordance with an embodiment of the present invention.

FIG. 6 illustrates a block diagram depicting an emergency software program in accordance with an embodiment of the present invention.

FIG. 7 illustrates a block diagram of a health care system in accordance with an embodiment of the present invention.

### DETAILED DESCRIPTION

Before describing in detail embodiments that are in accordance with the present invention, it should be observed that the embodiments reside primarily in combinations of method steps and system components related to sharing a user-medical-record. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or system that comprises, has, includes, contains a list of elements does not include only those elements but may include other elements not expressly listed or inherent to such process, method, article, or system. An element preceded by “comprises . . . a”, “has . . . a”, “includes . . . a”, “contains . . . a” does not, without more constraints, preclude the existence of additional identical elements in the process, method, article, or system that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and system for sharing a user-medical-record described herein. The non-processor circuits may include, but are not limited to, a transceiver, signal drivers, clock circuits and power source circuits. As such, these functions may be interpreted as steps of a method to share a user-medical-record described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention relates to sharing a user-medical-record with at least one emergency service provider or at least one medical-service-computing-device using a user-computing-device. Those skilled in the art will realize that the above recognized advantages and other advantages described herein are merely exemplary and are not meant to be a complete rendering of all of the advantages of the various embodiments of the present invention.

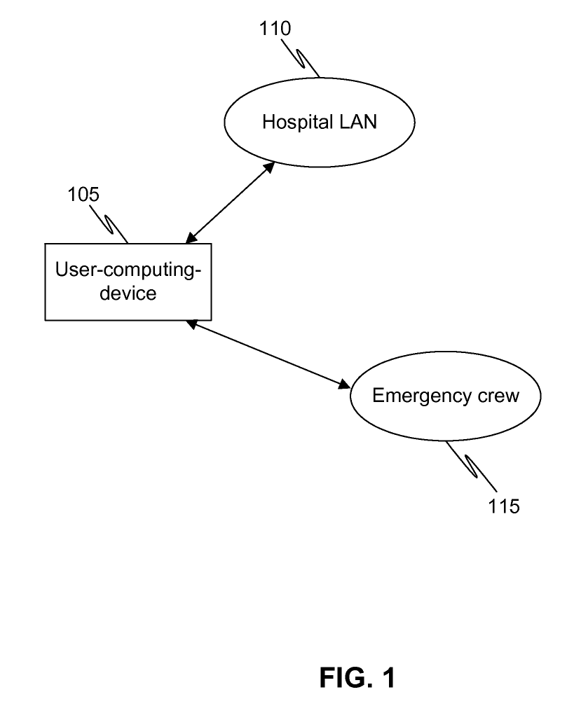

Referring now to the drawings, and in particular FIG. 1, a block diagram depicting a user-computing-device sharing a user-medical-record is shown in accordance with an embodiment of the present invention. Those skilled in the art, however, will recognize and appreciate that the specifics of this illustrative example are not specifics of the present invention itself and that the teachings set forth herein are applicable in a variety of alternative settings. For example, since the teachings described do not depend on the number of users or the type of communication technology used for sharing the user-medical-record, they can be applied to any number of users and any type of communication technology although only one user is shown in this embodiment. As such, other alternative implementations of using different types of communication technologies with a plurality of users are contemplated and are within the scope of the various teachings described.

In accordance with various embodiments of the present invention, the user carrying a user-computing-device 105 can store his user-medical-record or a secure-reference to his user-medical-record in user-computing-device 105. Further, user-computing-device 105 can also store a part of the user-medical-record and a secure-reference to the entire user-medical-record. The user-medical-record can be, for instance, the user's blood pressure, the user's glucose level or the user's blood type. User-computing-device 105 can be for example, a mobile phone, a laptop, a personal digital assistant (PDA), a digital camera or even an MP3 player. Typically, user-computing-device 105 can be any device that can be a carrier of the user-medical-record or at least of a relevant summary of the user-medical-record.

In an embodiment of the present invention, the user can transfer the user-medical-record from user-computing-device 105 to a hospital Local Area Network (LAN) 110. If a secure-reference to the user-medical-record is stored in user-computing-device 105, the secure-reference can be transferred to hospital LAN 110. The secure-reference can be, for instance, a password to the user's account on a website that can contain the user-medical-record. Those skilled in the art will realize that hospitals may have Information Technology (IT) infrastructures built using communication devices such as desktop computers and Local Area Network (LAN). The user can transfer at least one of the user-medical-record and the secure-reference from the user-computing-device 105 using various communications technologies such as wireless fidelity (WiFi) communication technology, Bluetooth Technology, Short Messaging Service (SMS), Over-The-Air (OTA) communication technology or a simple Universal Serial Bus (USB) port.

The user-medical-record can also be transferred to an emergency crew 115. Emergency crew 115 can be for example, a fire brigade and an ambulance. Since emergency crew 105 receives the user-medical-record of the user even before meeting the user, emergency crew 115 can grasp the user's current situation accurately and can prepare for the urgent requirements that the user might have. Therefore, this embodiment of the present invention facilitates optimized usage of the time of emergency crew 115 and of the hospital.

In an embodiment of the present invention, the hospital or emergency crew 115 can update the user-medical-record enabling the updated version of user-medical-record to be available at a later time.

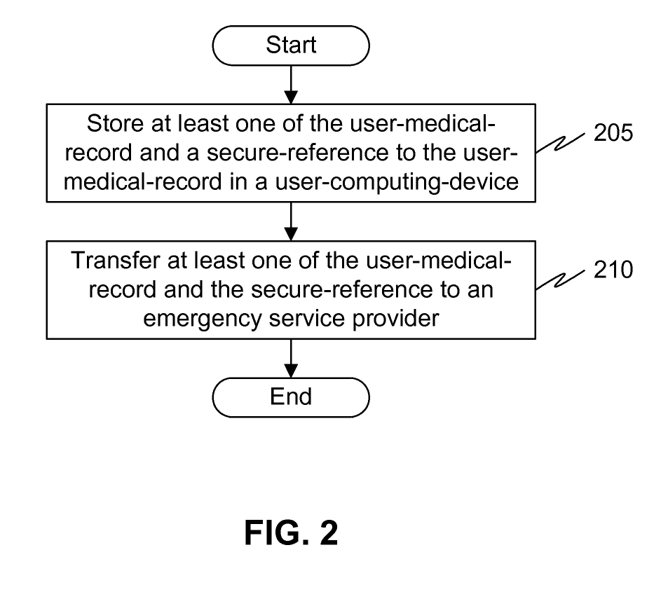

Turning now to FIG. 2, a flow diagram of a method of sharing a user-medical-record belonging to a user is shown in accordance with an embodiment of the present invention. At step 205, at least one of the user-medical-record and a secure-reference to the user-medical-record is stored in a user-computing-device. As mentioned earlier, the user-medical-record can be the user's blood pressure, the user's blood type or the user's glucose level. Those skilled in the art shall appreciate that storing the secure-reference instead of the user-medical-record facilitates saving of the memory space in the user-medical-record. Further, it provides an added security to the user-medical-record of the user. In an embodiment of the present invention, the secure-reference can comprise universal record locator (URL) and authorization information. The authorization information can be for example, a password to the account of the user on the URL. The secure-reference can be used to retrieve the user-medical-record from the URL in a secure manner.

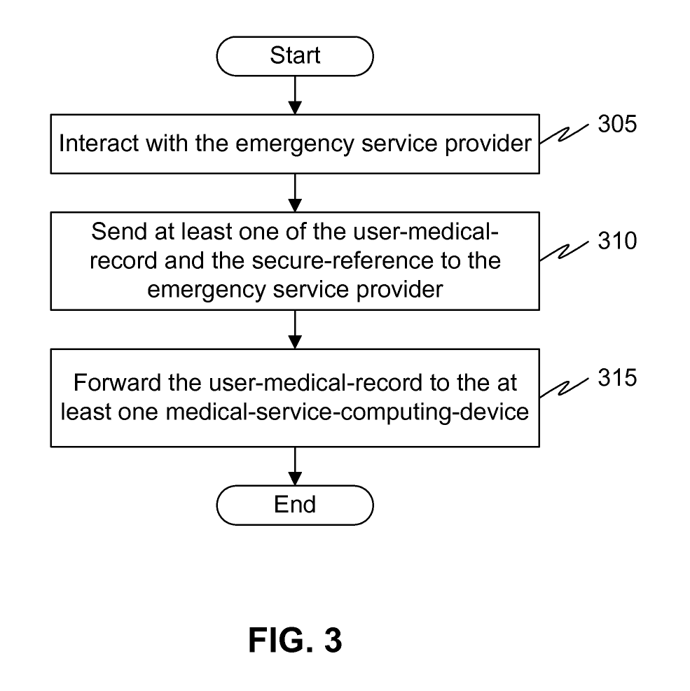

At step 210, the user-medical-record or the secure-reference to the user-medical-record is transferred to an emergency service provider. The method of transferring the user-medical-record and the secure-reference to the emergency service provider is explained in conjunction with the FIG. 3. In an embodiment of the present invention, the user can be either a registered-user or a non-registered-user. A registered user is associated with the emergency service provider. The association with emergency service provider can be achieved by subscribing to the services provided by the emergency service provider. On the other hand, a non-registered user is not associated with the emergency service provider to which the user-medical-record and the secure-reference are transferred. However, it would be apparent to a person skilled in the art that a non-registered user can be associated with other similar emergency service providers.

In an embodiment of the present invention, ubiquitous computing technologies are used to enable a medical-service-computing-device to recognize the user-computing-device and interact with it, irrespective of the operating system and network connectivity of the user-computing-device or of the medical-service-computing-device is. The medical-service-computing-device belongs to at least one of the emergency crew, a health care system and the hospital.

Further, the user-computing-device can store personal information of the user and in order to protect the personal information, a provision for encryption and decryption of the personal information can be given. The personal information can be the user's bank information, the user's web access history or any information that may not be relevant to the user's medical history or any information that a user may not want to share with the emergency service provider. The user-medical-record, such as the user's name, the user's social security number or information of the user's health care system, can be stored in a special access area. In an embodiment of the present invention, the special access area can only by accessed using the secure-reference to the user-medical-record. In another embodiment of the invention, separate authentication methods, such as those using certificates, can be required to access the user-medical-record and the personal information stored in the user-computing-device. Certificates can be, but are not limited to, X.509 certificates using public key techniques. This can protect the user's personal information from being accessed by the emergency service provider or more than one medical-service-computing-device. In addition, if a hospital is a part of the health care system of the user, then the hospital can immediately access relevant summary of the user information, which can also comprise the personal information of the user; otherwise, the hospital may need to request the user's personal information at a later time stamp.

Turning now to FIG. 3, a flow diagram of a method of transferring a user-medical-record and a secure-reference to the user-medical-record is shown in accordance with an embodiment of the present invention. To begin the process, a user can initiate an emergency call to an emergency service provider using a user-computing-device. The emergency service provider can be, for instance, a care center such as a police station. The user can dial 911 to interact with the emergency service provider. The user can then interact with the emergency service provider at step 305. In response to the user placing the emergency call, the user-medical-record of the user can be sent to the emergency service provider at step 310. In an embodiment of the present invention, instead of sending the user-medical-record, the secure-reference to user-medical-record can be sent to the emergency service provider. Further, in another embodiment of the present invention, a part of the user-medical-record can be sent to the emergency service provider in addition to the secure-reference of the user-medical-record. The secure-reference can comprise URL and authorization information such as a password to the account of the user on the URL. Using the secure-reference the user-medical-record can be retrieved from the URL. In an embodiment of the present invention, the user may not need to authenticate the emergency service provider it interacts with because it trusts the phone system, for instance, it trusts that only a genuine emergency service provider can be accessed by dialing 911.

Upon receiving the user-medical-record from the user or upon retrieving the user-medical-record from the URL, the emergency service provider can forward the user-medical-record to more than one medical-service-computing-device at step 315. The medical-service-computing-device belongs to at least one of the emergency crew, a health care system and the hospital. The emergency crew can be a fire brigade or an ambulance. Since the emergency crew receives the user-medical-record of the user even before meeting the user, the emergency crew can grasp the user's current situation accurately and can prepare for the urgent requirements that the user might have. Therefore, the method of FIG. 3 facilitates optimized usage of the time of emergency crew and of the hospital.

In order to maintain the update of the services allotted to a user in an emergency situation, the emergency service provider can comprise an information manager module. The information manager module can be coupled to a database of a list of the emergency crew and the health care systems dedicated to the user. When the user places the emergency call to the emergency service provider, the user-medical-record or the secure-reference to the user-medical-record can be automatically transferred to the emergency crew and the health care system dedicated to the user.

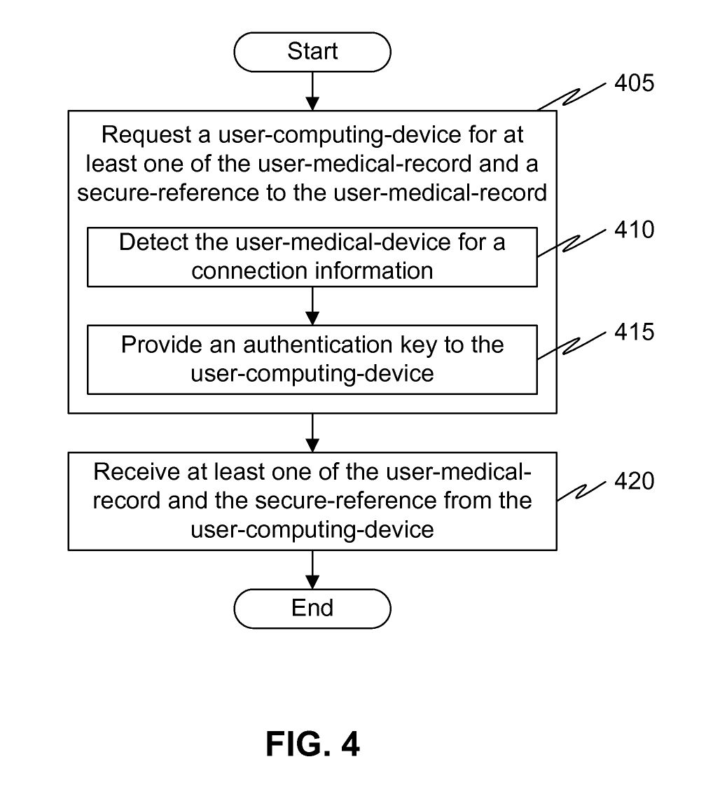

Turning now to FIG. 4, a flow diagram of a method of accessing a user-medical-record is shown in accordance with an embodiment of the present invention. A medical-service-computing-device belonging to an emergency crew or a health care system can request the user-computing-device to provide the user-medical-record or a secure-reference to the user-medical-record at step 405. Those skilled in the art shall realize that more than one medical-service-computing-device can request the user-computing device for the user-medical-record. For example, a medical-service-computing-device belonging to a fire brigade and a medical-service-computing-device belonging to an ambulance may wish to access a user-medical-record.

In an embodiment of the present invention, in order to gain access to the user-medical-record, the medical-service-computing-device can detect the user-computing-device for information regarding connection. At step 410, a brokering device detects the connection information that can be used by the medical-service-computing-device to establish a connection with the user-computing-device. The brokering device is a special-purpose device designed to bridge between a variety of user-computing-devices and a plurality of medical-service-computing-devices, which can both be general-purpose, of-the-shelf devices enhanced with software components. The main task of the brokering device is to find a way to establish network connectivity with the user-computing-device. Establishing network connectivity can include taking responsibilities such as that of a wireless base station and a DHCP server or running various networking profile, such as the Bluetooth profiles. The brokering device may need to accomplish this task with minimal or no support from the user-computing-device, as the user may not be aware of the arriving emergency crew. However, the emergency crew can typically support the brokering device by performing simple actions on the user-computing-device, such as turning it on, restoring it from hibernation or resetting it. The other tasks include establishing network connectivity to the medical-service-computing-device and tunneling information between the user-medical-device and the medical-service-computing-device, which is expected to be much easier tasks as the emergency crew has control over the medical-service-computing-device. The connection information can comprise the type of communication technology that can be used to transfer the user-medical-record or the secure-reference. The communication technology can be for instance, a wireless fidelity (WiFi) communication technology, Bluetooth Technology, Short Messaging Service (SMS), Over-The-Air (OTA) communication technology or a simple Universal Serial Bus (USB) port. In addition, the connection information of the user-computing-device can also mention dedication status of the emergency crew or the health care system to the user.

In the process of getting the connection information, the medical-service-computing-device of the emergency crew or the health care system may need to provide the user-computing-device with authentication information at step 415. The authentication information can be an authentication certificate or a certificate chain. In an embodiment of the invention, separate authentication can be required to access the user-medical-record and the personal information stored in the user-computing-device, and, the certificate may specifies the scope of the authentication. This can protect the user's personal information from being accessed by the emergency service provider or more than one medical-service-computing-device. In addition, if a hospital is a part of the health care system of the user, then the hospital can immediately access relevant summary of the user information, which can also comprise the personal information of the user, otherwise the hospital may need to request for the same at a later time stamp. In an embodiment of the present invention, an authentication certificate issued to the emergency crew or the health care system can be valid for a predefined time period. The predefined time period can be for example, a specified number of weeks from the day of issuing the authentication certificate, a specified number of hours from the time of issuing the authentication certificate. Making an authentication certificate issued to the emergency crew or the health care system valid only for the predefined time period facilitates in reducing a misuse of the authentication certificate for accessing the user-computing-device.

At step 420, the user-medical-record or a secure-reference to the user-medical-record is received by the medical-service-computing-device. In an embodiment of the present invention, if the user recognizes the medical-service-computing-device as a part of the user's health care system, the user-computing-device can simultaneously provide the medical-service-computing-device an access to the user-medical-record and the personal information of the user. A secure-reference, such as a URL, to the user-medical-record can be transferred to the medical-service-computing-device. Detailed information of the user-medical-record can be securely retrieved from the URL. Storing a secure-reference to the user-medical-record can therefore obviate the need to store the detailed information of the user-medical-record on the user-computing-device.

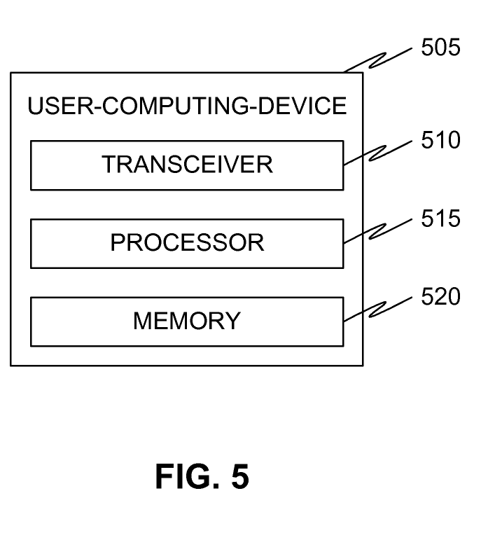

Turning now to FIG. 5, a block diagram of a user-computing-device 505 is shown in accordance with an embodiment of the present invention. User-computing-device 505 can be for example, a mobile phone, a laptop, a personal digital assistant (PDA), a digital camera or an MP3 player. Essentially, user-computing-device 505 can be a device that can be a carrier of a user-medical-record, a relevant summary of the user-medical-record or a secure-reference to the user-medical-record. User-computing-device 505 can comprise a transceiver 510. Transceiver 510 can be adapted for communication with other communication devices. For example transceiver 510 can be adapted for receiving an authentication certificate from other communication devices. Transceiver 510 is also adapted for transmitting the user-medical-record to other computing-device. Transceiver 510 can be adapted to communicate using various communication technologies for instance, Bluetooth technology, or a WiFi technology, Short Messaging Service (SMS), Over-The-Air (OTA) communication technology or a simple Universal Serial Bus (USB) port.

A processor 515 can be coupled to transceiver 510. Processor 515 can process the authentication certificate or other information received in transceiver 510. Processor 515 can also be enabled to send only a relevant summary of the user-medical-record to a medical-service-computing-device. Further, user-computing-device 505 can comprise a memory 520. Memory 520 can be configured for storing the user-medical-record and the personal information of the user. To conserve resources, memory 520 can store only a secure-reference to the user-medical-record or the relevant summary of the user-medical-record along with the secure-reference to the user-medical-record. As mentioned earlier, the secure-reference can be, for instance, a password to the account of the user on a website that can contain the user-medical-record.

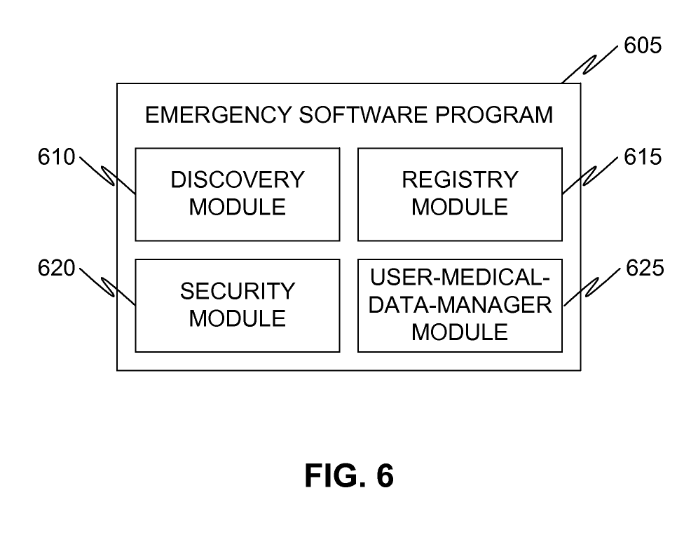

In an embodiment of the present invention, an emergency software program resides on memory 520 of user-computing-device 505. When an emergency crew meets the user or when the user is hospitalized for an emergency case, the doctors or the emergency crew can activate the emergency software program residing on user-computing-device 505. Upon activating the emergency software program, user-computing-device 505 can automatically transfer the user-medical-record, a relevant summary of the user-medical-record or a secure-reference to a medical-service-computing-device. The emergency software program is described in detail in conjunction with FIG. 6.

Turning now to FIG. 6, a block diagram depicting an emergency software program is shown in accordance with an embodiment of the present invention. An emergency software program 605 can reside on a user-computing-device belonging to a user. Emergency software program 605 can be activated either by the user or an emergency crew in case of an emergency.

Emergency software program 605 can comprise a discovery module 610. Discovery module 610 is adapted for receiving an activation request. Upon receiving the activation request, discovery module 610 discovers at least one medical-service-computing-device belonging to the emergency crew and or a health care system.

Once a list of medical-service-computing-devices belonging to the emergency crew and or the health care system in the neighborhood of the user-computing-device are discovered, at least one medical-service-computing-device that can be used easily for transferring a user-medical-record is chosen from the list. Those skilled in the art will realize that more than one medical-service-computing-device can also be chosen for transferring the user-medical-record. However, for exemplary purposes, only one medical-service-computing-device is considered in this embodiment.

A registry module 615 registers the chosen medical-service-computing-device. Registry module 615, essentially, stores connectivity information corresponding to the medical-service-computing-device for a predetermined time. The connectivity information of the medical-service-computing-device can enable the user to connect the user-computing-device with the medical-service-computing-device in future. The connectivity information can be an Internet Protocol (IP) address of the medical-service-computing-device and the communication technology used for the connection. The medical-service-computing-device may need to refresh after the predetermined time, else the medical-service-computing-device can be deregistered from the user-computing-device. Refreshing can comprise sending the connectivity information of the medical-service-computing-device after the predetermined time.

Those skilled in the art will realize that to register the user-computing-device or the user-medical-record with the medical-service-computing-device, a hospital system interface residing on the medical-service-computing-device can be used.

If a connection is established between the user-computing-device and the medical-service-computing-device, a security module 620 of emergency software program 605 can request the medical-service-computing-device for an authentication certificate. The authentication certificate or a certificate chain can provide the medical-service-computing-device with access to the user-medical-record or to a secure-reference to the user-medical-record stored in the user-computing-device. Security module 620 can then grant the medical-service-computing-device an access to the user-medical-record or the secure-reference to the user-medical-record or a relevant summary of the user-medical-record.

Emergency software program 605 further comprises a user-medical-data-manager module 625. User-medical-data-manager module 625 can be adapted for sending the user-medical-record or the secure-reference to the medical-service-computing-device. User-medical-data-manager module 625 can also send the user-medical-record or the secure-reference to an emergency service provider, such as a fire brigade, and the emergency service provider can forward the user-medical-record or the secure-reference to the medical-service-computing-device. As mentioned earlier, the emergency service provider can comprise an information manager module. The information manager module can be coupled to a database of a list of the emergency crew and the health care systems that are dedicated to the user.

In an embodiment of the present invention, user-medical-data-manager module 625 is also configured for updating the user-medical-record periodically. For example, each time a medical test is conducted on the user, user-medical-data-manager module 625 received an updated and an authenticated user-medical-record from the emergency service provider or the medical-service-computing-device. This can prevent erroneous user-medical-records from being stored in the user-computing-device.

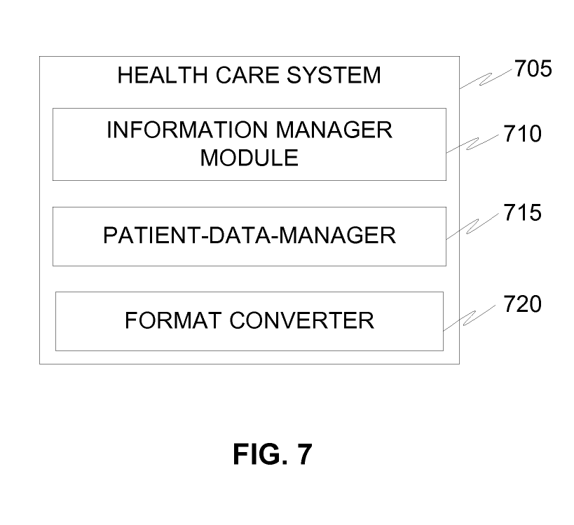

Turning now to FIG. 7, a block diagram of a health care system 705 is shown in accordance with an embodiment of the present invention. Health care system 705 can provide a user with medical services and health care services. Health care system 705 can be, for example, a hospital. Health care system 705 can comprise an information manager module 710. Information manager module 710 can comprise a list of the emergency crew or medical services that are assigned to the user. In case of an emergency, the emergency crew or medical services that are assigned to the user can be provided with the user-medical-record such as the user's blood type, the user's glucose level or the user's blood pressure. Therefore, the user-medical-record can be provided to the emergency crew either before or upon meeting the user, irrespective of the user's condition. However, those skilled in the art will realize that this is possible only if the user carries the user-computing-device, which comprises the user-medical-record or a secure-reference to the user-medical-record, when an emergency occurs.

Health care system 705 can also comprise a patient-data-manager 715. Patient-data-manager 715 can be responsible for managing a life cycle of the user-medical-record. When the life cycle is over, the user-medical-record is updated by requesting the user-computing-device for an updated user-medical-record.

Moreover, health care system 705 can also comprise a format converter 720. Format converter 720 can be enabled for converting the user-medical-record or the secure-reference of the user-medical-record into a format that is compatible with the format used by the health care system. Format converter 720 enables a seamless transfer of the user-medical-record across more than one medical-service-computing-device.

The various embodiments of the present invention provide a method and system that enables a user to have access to an improved medical service in case of an emergency. The user may not be at high risk and, therefore, may not be willing to pay for subscription services or provide private information to service providers in advance. By the virtue of the present invention, in case of an emergency, the emergency crew or the hospital can have access to the user-medical-record before meeting the user and, therefore, save on time. Obtaining quick access to a user's medical information can be very critical in case of an emergency. Moreover, the present invention can, especially, be useful for highly mobile users who can meet with a medical emergency while they are outside of their homes or workplaces.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method of sharing a user-medical-record belonging to a user, the method comprising:
a. storing at least one of the user-medical-record and a secure-reference to the user-medical-record in a user-computing-device; and
b. transferring securely one of the user-medical-record and the secure-reference to an emergency service provider, wherein the user is one of a registered-user and a non-registered-user, wherein the registered-user is associated with the emergency service provider and the non-registered-user is disassociated with said emergency service provider.

2. The method of claim 1, wherein the transferring step comprises:
a. interacting with the emergency service provider;
b. sending one of the user-medical-record and the secure-reference to the emergency service provider; and
c. forwarding the user-medical-record to the at least one medical-service-computing-device, wherein the medical-service-computing-device belongs to at least one of an emergency crew and a health care system, wherein the emergency service provider forwards the user-medical-record.

3. The method of claim 1, wherein the user-medical-record comprises at least one of a blood pressure, a glucose level and a blood type, the user-medical-record being updated periodically by the user.

4. The method of claim 1, wherein the user-computing-device is one of a mobile phone, a laptop, a personal digital assistant (PDA), a digital camera and an MP3 player.

5. The method of claim 2, wherein the medical-service-computing-device is one of a laptop, a medical equipment, a desktop, a personal digital assistant (PDA).

6. The method of claim 2, wherein the user-computing-device communicates wirelessly with at least one of the emergency service provider and the at least one medical-service-computing-device.

7. The method of claim 1, wherein the secure-reference comprises a universal record locator (URL) and an authorization information.

8. The method of claim 7, wherein the user-medical-record is retrieved based on the secure-reference.

9. The method of claim 2, wherein the sending step comprises sending a predefined information corresponding to the user-medical-record.

10. The method of claim 2, wherein the at least one medical-service-computing-device is one of an ambulance-computing-device, a fire-brigade-computing-device and a hospital-staff-computing-device.

11. A method of accessing a user-medical-record, the method comprising:
a. requesting a user-computing-device for at least one of the user-medical-record and a secure-reference to the user-medical-record, wherein at least one medical-service-computing-device requests the user-computing-device; and
b. receiving one of the user-medical-record and the secure-reference from the user-computing-device, wherein at least one medical-service-computing-device receives the at least one of the user-medical-record and the secure-reference, wherein the at least one medical-service-computing-device belongs to at least one of an emergency crew and a health care system.

12. The method of claim 11, wherein the requesting step comprises:
a. detecting the user-medical-device for a connection information, wherein a brokering device detects the connection information to be used with the user-medical-device; and
b. providing one of an authentication certificate and an authentication certificate chain to the user-computing-device, one of the authentication certificate and the authentication certificate chain allowing access to at least one of the user-medical-record and the secure-reference.

13. The method of claim 12, wherein the authentication certificate is valid for a predefined time period.

14. The method of claim 13, wherein the predefined time period can be one of a specified number of days and a specified number of hours.

15. The method of claim 11, wherein the at least one medical-service-computing-device uses the ubiquitous computing technology, the ubiquitous computing technology enabling the at least one medical-service-computing-device and the health care system to recognize and communicate with user-computing-device.

16. A user-computing-device, the user-computing-device comprising:
a. a transceiver;
b. a processor coupled to the transceiver;
c. a memory coupled to the processor, the memory configured to store at least one of a user-medical-record and a secure-reference to the user-medical-record; and
d. an emergency software program residing in the memory.

17. The user-computing-device of claim 16, wherein the emergency software program comprises:
a. discovery module adapted for:
i. receiving an activation request; and
ii. discovering at least one medical-service-computing-device in response of the activation request, wherein the at least one medical-service-computing-device belongs to at least one of an emergency crew and a health care system.
b. a registry module adapted for:
i. storing a connectivity information corresponding to the at least one medical-service-computing-device for a predetermined time.
c. a security module adapted for:
i. receiving one of an authentication certificate and an authentication certificate chain from the at least one medical-service-computing-device, one of the authentication certificate and the authentication certificate chain facilitating access to the user-medical-record; and
ii. granting access in response of receiving one of the authentication certificate and the authentication certificate chain.
d. a user-medical-data-manager module adapted for:
i. sending at least one of the user-medical-record and the secure-reference to at least one of an emergency service provider, and the at least one medical-service-computing-device.

18. The user-computing-device of claim 17, wherein the user-data-manager module is further adapted for updating the user-medical-record periodically.

19. The user-computing-device of claim 17, wherein the health care system comprises
a. an information manager module, managing at least one medical service assigned to the user;
b. a patient-data-manager, the patient-data-manager managing a life cycle of the user-medical-record; and
c. a format converter, the format converter converting at least one of the user-medical-record and the secure-reference of the user-medical-record into a compatible format.
